(19) United States
(12) Patent Application Publication
(10) Pub. No.: US 2002/0052856 A1
(43) Pub. Date: May 2, 2002

(54) Method of data-dependence analysis and display for procedure call

(76) Inventor: Makoto Satoh, Machida (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/905,912

(22) Filed: Jul. 17, 2001

(30) Foreign Application Priority Data
Aug. 25, 2000 (JP) 2000-260862

(51) Int. Cl. G06F 15/18

(52) U.S. Cl. 706/4

(57) ABSTRACT

A method of data dependence analysis and display of the present invention, from a given program, creates a hierarchical control flow graph containing one of procedure call, basic block, and loop as anode; when a data dependence source or data dependence destination is a procedure call node, loop node, or basic block node, on the hierarchical control flow graph, or a statement analyzes reference regions for a control flow graph for a hierarchy subordinate to the procedure call node or loop node, statements within the basic block, or reference points in the statement; and compares the reference regions to decide the data dependence source and data dependence destination. The above processing is performed on a step-by-step basis, beginning from a specified loop.

### BACKGROUND OF THE INVENTION

The present invention relates to a program analysis system that inputs a source program to display data dependence sources and data dependence destinations, or a program tuning method for supporting operations for tuning the program to a specific system.

Conventional analysis tools for displaying data dependence sources and data dependence destinations within a specified loop analyze and display data dependence sources and data dependence destinations, noting only one loop within one procedure, as described in Mary W. Hall, et al., Experiences Using the ParaScope Editor: an Interactive Parallel Programming Tool, PPOPP '93, pp. 33-43, May, 1993.

The above described technology has a problem in that, where a data dependence source or data dependence destination calls a procedure, since it cannot be displayed where the data dependence source or data dependence destination exists within the procedure or a different procedure called directly or indirectly from the procedure, the user must locate them by themselves, imposing a heavy load on the user.

Also, the above described technology has a problem in that, since it checks for the existence of data dependence for pairs of all reference points that may have data dependence relationships, a wider checking range would take a longer analysis time.

Also, the above described technology has a problem in that, since data dependence sources and data dependence destinations are displayed within one window, in the case where data dependence sources and data dependence destinations exist at distant positions on a program, such as the case of data dependence spanning plural procedures, they cannot be displayed at the same time, with the result that the user must perform troublesome operations such as the scrolling of the window to view both of them.

Also, the above described technology has a problem in that, although a dependence vector is displayed for an array having data dependence, since it is not displayed in which subscript range the array must be attentively checked, inefficiently, the user may check data dependence, including subscript ranges not having data dependence.

Also, the above described technology has a problem in that, although data dependence sources and data dependence destinations are displayed on an input program, even variables converted to constants by a compiler are displayed in the form of variables on the program, and when the user checks for the existence of data dependence, inefficiently, he must make replacements while checking the values of the variables.

### SUMMARY OF THE INVENTION

An object of the present invention is, when a data dependence source or data dependence destination calls a procedure, to display where the data dependence source or data dependence destination exists within the procedure or a different procedure called directly or indirectly from the procedure. Another object of the present invention is to reduce analysis time and data quantity at the time of an analysis of data dependence.

Another object of the present invention is, even when data dependence sources and data dependence destinations are in different procedures, to display the data dependence sources and data dependence destinations, and programs around them at the same time. Also, another object of the present invention is to display dependence information for an array along with information indicating in which subscript range the array may have dependence relationships. Also, another object of the present invention is to display data dependence sources and data dependence destinations on programs and also display variables converted to constants by a compiler as the constants on the programs.

To achieve the above objects, the method of data dependence analysis and display of the present invention performs the following steps:

1) a hierarchical control flow graph creation step that, from a given program, creates a hierarchical control flow graph, containing one of procedure call, basic block, and loop as a node, obtained by connecting a control flow graph of a procedure call node and a called procedure, and connecting a control flow graph for a loop node and statements within the loop;

2) a reference region analysis step that analyzes reference regions for nodes existing in a control flow graph forming one hierarchy in the hierarchical control flow graph, statements within one basic block, or reference points in one statement; and

3) a data dependence analysis step that compares the reference regions, and decides nodes, statements within a basic block, or reference points within a statement on the hierarchical control flow graph, which constitute data dependence sources and data dependence destinations.

To achieve the above described another object, when a data dependence source or data dependence destination is a procedure call node, loop node, basic block node, or statement on the hierarchical control flow graph, a step-by-step dependence decision step is provided which respectively applies the reference region analysis step and the data dependence analysis step to a control flow graph for a hierarchy subordinate to the procedure call node or loop node, the basic block, or the statement.

Also, to achieve the above described another object, a data dependence display step is provided which displays a data dependence source and a program around it and a data dependence destination and a program around it respectively on different windows.

Also, to achieve the above described another object, the data dependence display step is provided which displays data dependence sources and data dependence destinations and also their respective reference regions.

Also, to achieve the above described another object, an output program display step is provided which displays programs outputted by a compiler and also data dependence sources and data dependence destinations.

### BRIEF DESCRIPTION OF THE DRAWINGS

Preferred embodiments of the present invention will be described in detail based on the followings, wherein:

FIG. 1 shows a procedure of a program analysis method of the present invention;

FIG. 2 is a concrete example of an input program 121;

FIG. 3 illustrates a hierarchical control flow graph 112 for the input program 121;

FIG. 4 is a drawing showing a program representation of an intermediate language 111 obtained as a result of applying an interprocedural scalar variable analysis 105 to the input program 121;

FIG. 5 shows a loop display window for the input program 121;

FIG. 6 is a drawing showing a data-dependence display window for the input program 121;

FIG. 7 shows the input program 121 in which directives have been inserted by step-by-step dependence decision 133;

FIG. 8 shows the data dependence display window in which more detailed data dependence information has been obtained by application of the step-by-step dependence decision 133; and

FIG. 9 shows an output program display window in which more detailed data dependence information has been obtained by application of the step-by-step dependence decision 133.

### DESCRIPTION OF THE PREFERRED EMBODIMENTS

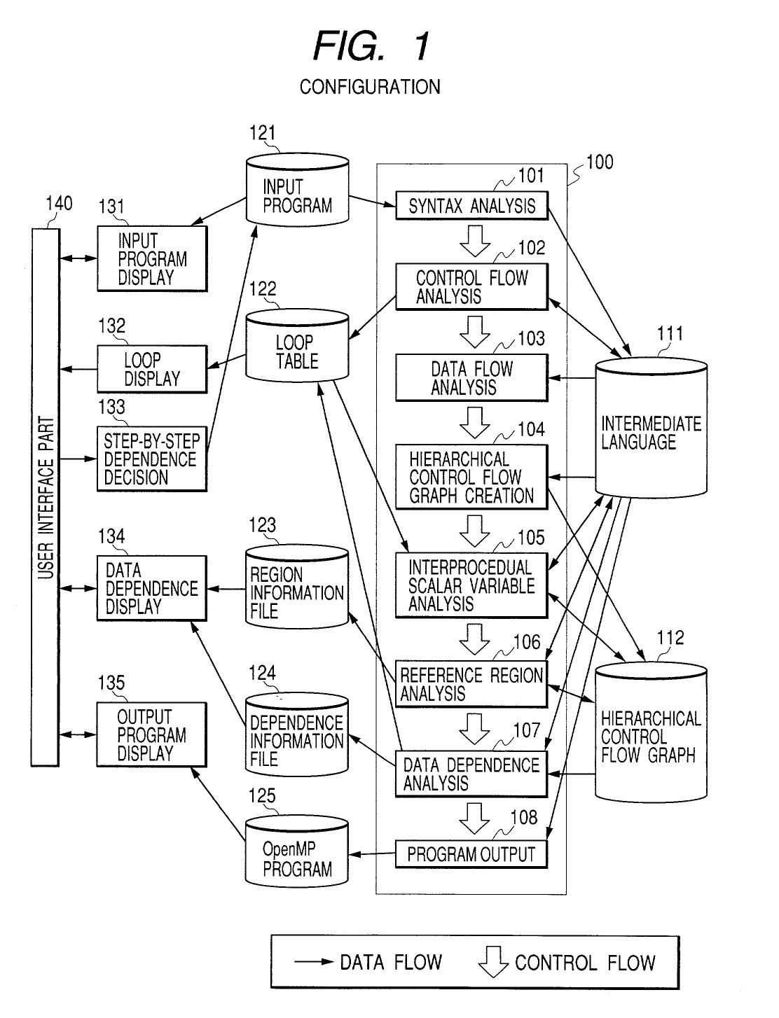

Hereinafter, an embodiment of the present invention will be described with reference to FIGS. 1 to 9.

FIG. 1 shows a procedure of a program analysis method of the present invention. The program analysis method shown in FIG. 1 is carried out using a computer having input-output devices and an external storage.

A compiler 100 comprises the following processing parts:

a syntax analysis part 101 that inputs an input program 121 and outputs an intermediate language 111;

a control flow analysis part 102 that inputs the intermediate language 111, analyzes a control flow, and outputs the intermediate language 111 containing basic blocks and a rule table 122;

a data flow analysis part 103 that inputs the intermediate language 111 and analyzes a data flow;

a hierarchical control flow graph creation part 104 that inputs the intermediate language 111 and outputs a hierarchical control flow graph 112 spanning plural procedures;

an interprocedural scalar variable analysis part 105 that inputs the intermediate language 111 and the loop table 122 to carry out an interprocedural scalar variable data flow analysis, interprocedural constant propagation, and procedure cloning, and reflects the results in the intermediate language 111 and the hierarchical control flow graph 112;

a reference region analysis part 106 that inputs the intermediate language 111 and the hierarchical control flow graph 112 to carry out a reference region analysis of reference points, and reflects the results in the intermediate language 111 or the hierarchical control flow graph 112, and outputs reference regions in procedure nodes, loop nodes, or nodes and statements having data dependence relationships in loops specified in directives inserted in procedures to a region information file 123;

a data dependence analysis part 107 that inputs the intermediate language 111 and the hierarchical control flow graph 112, detects data dependence by comparing reference points or statements in the intermediate language 111, or nodes in the hierarchical control flow graph 112, and outputs the results to a data dependence information file 124; and

a program output part 108 that inputs the intermediate language 111 and outputs an OpenMP program.

Basic blocks are processing parts separated by branch or join in a processing flow.

OpenMP is program parallelization specifications intended for shared memory multi-processor, and a description of it is omitted since details of it are found in http://www.openmp.org. October, 1997 (OpenMP Architecture Review Board, “OpenMP Fortran Application Program Interface Ver 1.0”, http://www.openmp.org.Oct. 1997.

Input program display 131 inputs position information of two statements having a data dependence relationship with each other, highlighted on a window displayed by data dependence display 134, through a user interface part 140, inputs the input program 121, and outputs, to the user interface part 140, interface information for displaying one statement and an input program around the statement on one window and another statement and a program around the statement on a different window.

Loop display 132 inputs the loop table 122 and outputs interface information for displaying a list of loops to the user interface part 140.

Step-by-step dependence decision 133 inputs, for a data dependence source and a data dependence destination highlighted on windows displayed by the data dependence display 134, position information of the respective procedures to which they belong and the loops to be analyzed for data dependence, inserts them to the input program 121 in the form of directives, activates the compiler 100, and activates the data dependence display 134 so as to display detailed dependence information and region information obtained as a result.

The data dependence display 134 inputs position information of a user-specified loop on a window displayed by the loop display 132, inputs dependence information for the loop and region information for variables to cause the dependence from the data dependence information file 124 and the region information file 123, respectively, and outputs, to the user interface part 140, interface information for displaying the results on a window for displaying dependence types, a window for displaying data dependence source information, and a window for displaying data dependence destination information.

Output program display 135 inputs position information of two statements having a data dependence relationship with each other, highlighted on a window displayed by the data dependence display 134, through the user interface part 140, inputs the OpenMP program 125, and outputs, to the user interface part 140, interface information for displaying one statement and an input program around the statement on one window and another statement and a program around the statement on a different window.

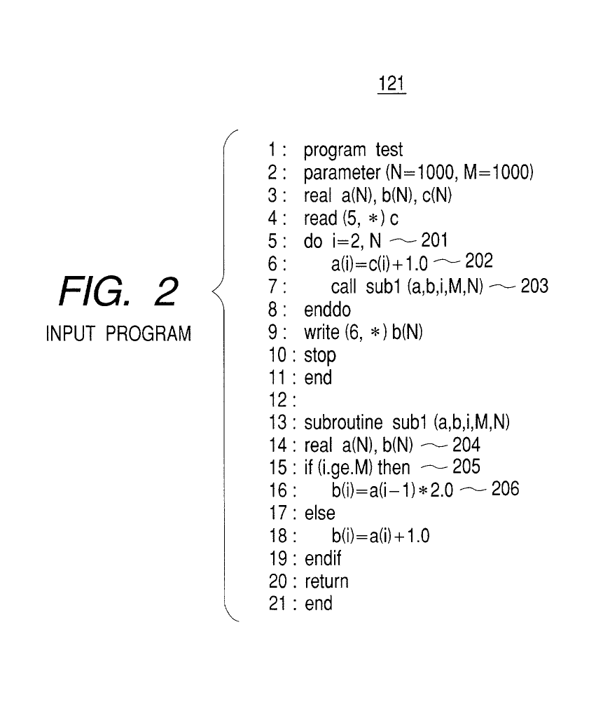

The operation and display of a program analysis system of the present invention will be described based on FIG. 1 and using a concrete example shown in FIGS. 2 to 9.

The compiler 100 is activated to analyze an input program and output various types of information.

FIG. 2 is a concrete example of the input program 121. Leftmost numbers in the drawing designate line numbers.

The syntax analysis part 101 in the compiler 100 inputs the input program 121 in FIG. 2 and outputs an intermediate language 111. Hereinafter, the intermediate language 111 will also be represented in a program format. Accordingly, FIG. 2 shows the intermediate language 111 immediately after being subjected to the syntax analysis 101.

The control flow analysis part 102 and the data flow analysis part 103 input the intermediate language 111, create basic blocks and loop information, add the basic blocks to the intermediate language 111, and output the loop information to a loop table 122. Details of these processes are omitted because they are described in Alfred V. Aho, Ravi Sethi, Jeffrey D. Ullman. “Compilers principles, techniques, and tools”, Addison-Wesley, 1985.

The hierarchical control flow graph creation part 104 inputs the intermediate language 111 corresponding to the input program 121 shown in FIG. 2, and outputs a hierarchical control flow graph 112.

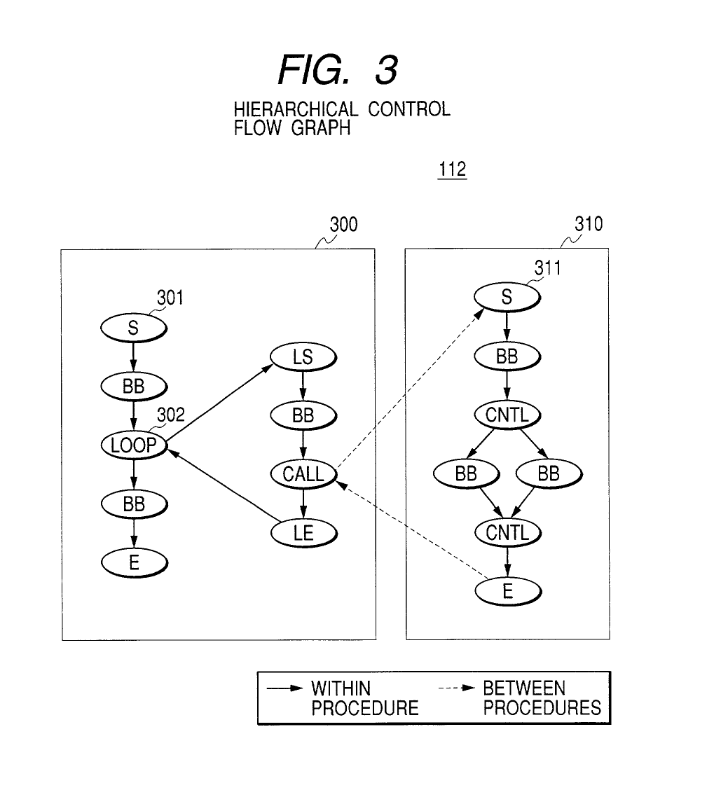

FIG. 3 shows a hierarchical control flow graph 112 obtained in this way. A graph 300 is a hierarchical control flow graph for a procedure test, and a graph 310 is a hierarchical control flow graph for a procedure sub1. There are eight types of nodes including S, E, BB, LOOP, LS, LE, CALL, and CNTL. S designates an entry node; E, an exit node of a procedure; BB, a node representative of a basic node or a part of a basic node; LOOP, a node representative of a loop; LS, an entry node of a loop body; LE, an exit node of a loop body; CALL, a node representative of procedure call; and CNTL, a node representative of control flow branch or join. An edge with a direction for connecting nodes indicates the existence of a control flow heading from a starting point of the edge to an ending point. An edge for connecting a CALL statement and a called procedure is an edge spanning plural procedures and is differentiated from edges for connecting nodes within a procedure.

The interprocedural scalar variable analysis part 105 inputs the intermediate language 111, the hierarchical control flow graph 112, and the loop table 122, performs transformations such as an analysis spanning plural procedures and procedural constant propagation, and reflects the results in the intermediate language 111 and the hierarchical control flow graph 112. Details of the procedural constant propagation are omitted because it is described in D. Grove, L. Torczon, “Interprocedural Constant Propagation: A study of Jump Function Implementation”, In Proceedings of PLDI'93, June 1993.

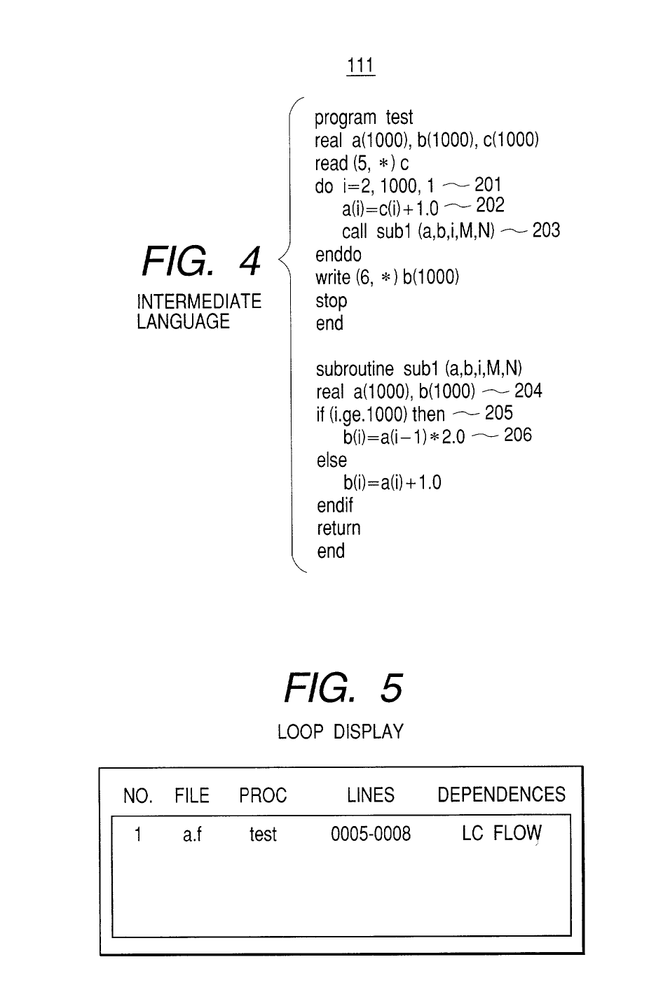

FIG. 4 shows the intermediate language 111 resulting from transformation by the interprocedural scalar variable analysis 105. Since the values of variables N and M are respectively set to 1000 by a parameter statement of line number 2 of FIG. 2, N in a statement 201 of FIG. 2 is set to 1000 in FIG. 4. Interprocedural constant propagation is applied to the values of the two variables N and M, and these values are propagated from a statement 203 to the called procedure sub1. As a result, the value of N in a statement 204 becomes 1000 and the value of M in a statement 205 becomes 1000.

The reference region analysis part 106 inputs the intermediate language 111 of FIG. 4 and the hierarchical control flow graph 112 of FIG. 3, carries out a reference region analysis of reference points, reflects the results in the intermediate language 111 or the hierarchical control flow graph 112, adds reference regions in the procedure entry nodes 301 and 311 and the loop node 302 of the hierarchical control flow graph to the nodes, and outputs the reference regions to the region information file 123. Region information represents which elements in a given array were accessed, using a subscript range of the array for each access type.

As a method of representing regions, herein, a range of subscripts is specified using three numbers consisting of an initial value, a final value, and stride for each dimension of the array. As access types, MOD, USE, KILL, and EUSE are taken into account. MOD indicates array elements whose values may be modified in a certain program portion. USE indicates array elements whose values may be used in a certain program portion. KILL indicates array elements whose values will be modified without fail in a certain program portion. EUSE indicates array elements that may be used before being modified in a certain program portion. Regions for these are respectively referred to as MOD, USE, KILL, and EUSE regions.

Calculations are made of three types of regions ONE, PREV, and ALL on loop iteration count that are useful for analyzing data dependence for a loop. ONE, PREV, and ALL respectively denote a region in i-th execution of a loop, a union of regions up to (i−1)-th execution of a loop from a start value, and a union of regions for all repetitions of a loop. For example, there will be provided below region information for a loop 201 on an array a in a statement 202 of FIG. 4.

ONE regions on MOD, USE, KILL, and EUSE for array a are respectively {i}, { }, {i}, and { }. PREV regions on MOD, USE, KILL, and EUSE for array a are respectively {2:i−1:1}, { }, {2:i−1:1}, and { }. ALL regions on MOD, USE, KILL, and EUSE for array a are respectively {2:1000:1}, { }, {2:1000:1}, and { }.

The data dependence analysis part 107 inputs the hierarchical control flow graph 112, detects loop nodes in the graph, determines the existence of data dependence, data dependence source, and data dependence destination by comparing region information added to nodes at a hierarchy subordinate to each loop node, and outputs the results to the data dependence information file 124.

Herein, only loop-carried flow dependence is taken into account. The existence of loop-carried flow dependence for a certain array denotes that there is an overlap between PREV region on MOD and ONE region on EUSE for the array. Loop-carried flow dependence for the loop 201 exists in the array a, and PREV region on MOD in statement 202 is {2:i−1:1} and ONE region on EUSE in statement 203 is {i−1:i:1}. The program output part 108 inputs the intermediate language 111 of FIG. 4 and outputs the OpenMP program 125.

This terminates processing in the first stage by the compiler 100.

Next, a description will be made of the operation and display of the program analysis system when the user selects the loop display function and the data dependence display function in that order.

When the user selects the loop display function through the user interface part 140, the program analysis system activates the loop display 132, which inputs information about the loop 201 from the loop table 122 and outputs it.

FIG. 5 shows an example of loop display. Items “NO”, “FILE”, “PROC”, “LINES”, and “DEPENDENCES” respectively indicates: a serial number of loop; file name to which the loop belongs; procedure name to which the loop belongs; line number of DO statement and line number of ENDDO statement of the loop, concatenated by a hyphen; and data dependence type. “zLC FLOW” in data dependence indicates loop-carried flow dependence.

Next, when the user selects a line in the window displayed in FIG. 5 and selects the data dependence display function, position information of a selected loop is passed, through the user interface part 140, to the data dependence display 134, which extracts information about the loop from the data dependence information file 124 and the region information file 123, and passes information for displaying the results to the user interface part 140.

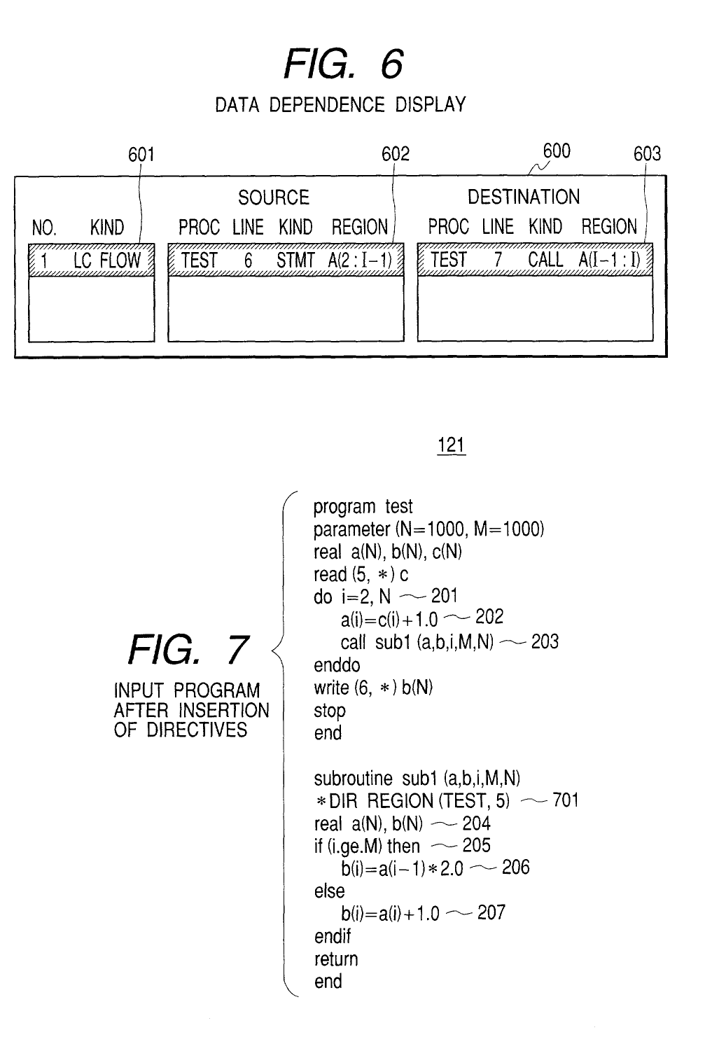

FIG. 6 shows an example of data dependence display. A data dependence display window 600 consists of three subwindows. A subwindow 601 displays data dependence types. Symbols used here are the same as those in FIG. 5. A subwindow 602 displays information about data dependence sources. Items “PROC”, “LINE”, “KIND”, and “REGION” respectively indicates: procedure name to which statement of data dependence source belongs; line number of statement of data dependence source; type of statement of data dependence source; and reference region of array name and array element to cause data dependence to loop selected in FIG. 5. Herein, the type of statement of data dependence source is “STMT” for statement containing no procedure call, and “CALL” for statement containing procedure call. Reference regions of array elements to cause data dependence differ in regions to be displayed, depending on data dependence type, data dependence source, and dependence destination. In the case of FIG. 6, since data dependence type is loop-carried flow dependence, in data dependence source, PREV region on MOD is displayed, and in data dependence destination, ONE region on EUSE is displayed. A subwindow 603 displays information about data dependence destination. Displayed items are the same as those on the subwindow 602. Individual lines correspond among the subwindows.

Next, a description will be made of the operation and display of the program analysis system when, in the data dependence display, the user displays detailed information about data dependence destination.

When the user selects the first line in the subwindow 603, all the first lines in the subwindows 601, 602, and 603 are highlighted. Next, when the user selects the detailed information display function, the user interface part 140 activates the step-by-step dependence decision 133 and affords information about selected data dependence destination to the step-by-step dependence decision 133. In this case, the information to be afforded is a called procedure name sub1, a procedure name test in which the loop to be analyzed exists, and a line number 5 of DO statement of the loop.

The step-by-step dependence decision 133 inserts these information items in the input program 121 as directives. FIG. 7 shows a program obtained as a result. Statement 701 is a directive inserted by the step-by-step dependence decision 133. The directive is inserted at the beginning of the procedure sub1 in which data dependence is analyzed in detail. In the directive; “*DIR” is a keyword character string indicating a directive, and a following character string “REGION” is a character string indicating a directive related to reference region. “TEST” indicates a procedure name to which a loop to be analyzed belongs, and “5” indicates a line number of the loop to be analyzed.

Next, the step-by-step dependence decision 133 activates the compiler 100, which inputs the input program 121 of FIG. 7 in which the directive is inserted, and analyzes it.

The reference region analysis part 106 outputs region information of each statement in the procedure sub1 in which the directive is inserted, to the region information file 123.

The data dependence analysis part 107 compares region information of each statement within the procedure sub1, compares region information of each statement except the procedure call 203 within the loop 201, and compares region information of statements except the procedure call 203 within the loop 201 and region information of each statement within the procedure sub1, the region information being information transformed into region information within the procedure test, to decide pairs of statements having a data dependence relationship with each other, and outputs the results to the data dependence information file 124.

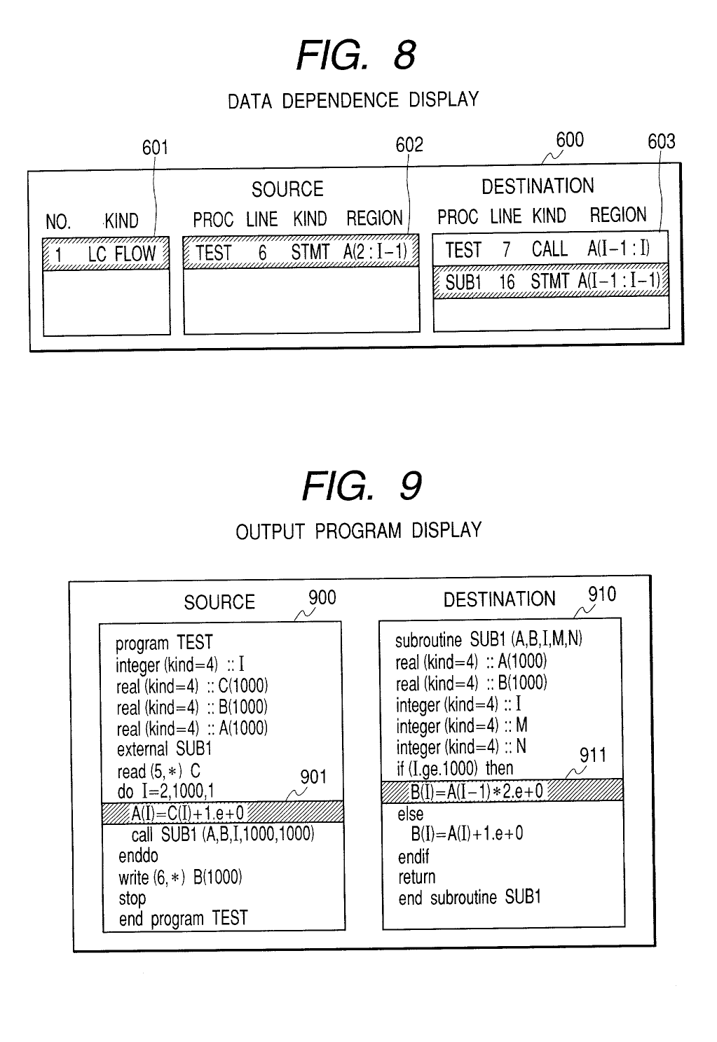

Next, the step-by-step dependence decision 133 activates the data dependence display 134, and fetches the most recent analysis information from the data dependence information file 124 and the region information file 123 to display it. FIG. 8 shows a data dependence display window displayed as a result. The first line of the subwindow 603 is not highlighted, and instead, the second line is highlighted. On the second line, data dependence destination information corresponding to a statement 206 within the procedure sub1 is displayed. This display tells that a data dependence destination first identified simply by a statement 203 is the sixteenth statement 206 of the called procedure sub1.

The above results can also be displayed on the program.

When the user selects the output program display function in the data dependence display window, position information of each of statements highlighted on the data dependence display window is passed, through the user interface part 140, to the output program display 135, which inputs the OpenMP program 125 and passes, to the user interface part 140, interface information for displaying the statements and programs around the statements on different windows for each of data dependence source and data dependence destination.

FIG. 9 shows output program display windows displayed as a result. A window 900 is a subwindow displaying a data dependence source and a program around it, and a window 910 is a subwindow displaying a data dependence destination and a program around it. A statement 901 is highlighted to display a data dependence source, and a statement 911 is highlighted to display a data dependence destination.

The foregoing embodiment is an offline embodiment that inserts directives in an input program according to a user command, reactivates the compiler 100, and obtains detailed analysis results.

On the other hand, an online embodiment is also possible which, with the compiler 100 activated, marks nodes of a hierarchical control flow graph for a user-specified procedure, reactivates the reference region analysis 106 and the data dependence analysis 107 in the compiler, and reanalyzes an entire program or a program portion following a marked procedure, thereby obtaining detailed analysis results.

The step-by-step dependence decision 133 in this embodiment, when a node on a hierarchical control flow graph in a lower hierarchy of at least one of a data dependence source and a data dependence destination is specified by the user, carries out a more detailed analysis for statements in a basic block if the node is a basic block, or reference points in the statements.

On the other hand, the step-by-step dependence decision 133, without receiving a user command, when at least one of a data dependence source and a data dependence destination has nodes, statements, or reference points in a lower hierarchy, carries out an analysis for them again, whereby automatic analysis by the compiler is possible.

The software according to the present invention that has the function for indicating data dependence sources and data dependence destinations to the user operates as a more useful program development environment tool when functions described below are provided.

For example, one of such functions is one that, when data dependence sources and data dependence destinations are identified by a function of the present invention and the user judges that they do not impede loop parallelization, creates inserts parallelization directives for the loop according to a user command so that the compiler parallelizes the loop.

Another function is one that, when data dependence sources and data dependence destinations are identified by a function of the present invention and the user judges that they impede loop parallelization, enables the user to edit a program in which the data dependence source or data dependence destination is displayed, displayed by the input program display 131 or output program display 135.

Another function is one that, when data dependence sources and data dependence destinations are identified by a function of the present invention, judges whether the data dependence relationship impedes loop parallelization, and displays a result.

Another function is one that displays whether the above judgment result by a computer is definite or indefinite.

The above described additional functions have been described exemplifying parallelization, which is applicable to all program transformations that employ data dependence analysis results, such as vectorization and loop transformation.

A program for implementing the above described program analysis method can be stored in storage media such as a floppy disk or optical disk so that the program can be read into a main memory of a computer for execution.

According to the present invention, since data dependence source or data dependence destination can be displayed spanning plural procedures, the user can be relieved of the load of examining data dependence.

Also, according to the present invention, since a data dependence source and data dependence destinations can be decided step by step tracing a hierarchical control flow graph from a specified loop, the range of a program to be analyzed can be narrowed down, the number of comparisons for detecting data dependence can be reduced, the amount of data to be analyzed can be reduced, so that an analysis time and the quantity of data to be analyzed can be cut.

Also, according to the present invention, even when data dependence sources and data dependence destinations are respectively contained in different procedures, since the data dependence sources and data dependence destinations, and programs around them can be displayed at the same time, the user can be relieved of the load of displaying positions having data dependence.

Also, according to the present invention, since dependence information for array data can be displayed along with information indicating in which subscript range the array data has dependence relationships, the existence of dependence relationships in the array can be checked with a special attention to the range, contributing to efficient examination of data dependence relationships.

Also, according to the present invention, since data dependence sources and data dependence destinations can be displayed on programs outputted by the compiler, if an array extent, the values of upper and lower bounds of a loop, and the values of conditional expressions in the programs are replaced with constants by the compiler, the user will be able to efficiently check for the existence of data dependence.

What is claimed is:

1. A method of data dependence analysis and display that uses a processor to display data dependence sources and data dependence destinations within a specified loop in a program, the method comprising the steps of:
analyzing whether said data dependence sources or data dependence destinations exist within a procedure called from the loop; and
displaying positions of said data dependence sources or data dependence destinations within the procedure.

2. The analysis and display method according to claim 1, wherein said position display is made in response to a user-specified procedure call.

3. The analysis and display method according to claim 1, wherein, in said position display, programs containing data dependence sources and programs containing data dependence destinations are displayed on different windows.

4. The analysis and display method according to claim 3, wherein said programs are those that are created by a compiler or a language transformation system.

5. The analysis and display method according to claim 1, wherein, in said position display, a subscript range of an array in which data dependence occurs is displayed.

6. The analysis and display method according to claim 1, wherein, in said position display, a procedure call sequence between the specified loop and data dependence sources, and a procedure call sequence between the specified loop and data dependence destinations are displayed.

7. A method of data dependence analysis and display that uses a processor to display data dependence sources and data dependence destinations within a specified loop in a program, the method comprising:
a hierarchical control flow graph creation step that, from a given program, creates a hierarchical control flow graph, containing one of procedure call, basic block, and loop as a node, obtained by connecting a control flow graph of a procedure call node and a called procedure, and connecting a control flow graph for a loop node and statements within the loop;
a reference region analysis step that analyzes reference regions for nodes existing in a control flow graph forming one hierarchy in the hierarchical control flow graph, statements within one basic block, or reference points in one statement; and
a data dependence analysis step that compares the reference regions, and decides nodes on said hierarchical control flow graph, statements within a basic block, or reference points within a statement, which constitute data dependence sources and data dependence destinations.

8. The method of data dependence analysis and display according to claim 7, further including:
a step-by-step dependence decision step which, when a data dependence source or data dependence destination is a procedure call node, loop node, or basic block node on said hierarchical control flow graph, or a statement respectively applies the reference region analysis step and said data dependence analysis step to a control flow graph for a hierarchy subordinate to said procedure call node or loop node, said basic block, or said statement.

9. The method of data dependence analysis and display according to claim 7, further including:
a data dependence display step which displays a data dependence source and a program around it and a data dependence destination and a program around it respectively on different windows.

10. The method of data dependence analysis and display according to claim 9, wherein said data dependence display step displays data dependence sources and data dependence destinations and also their respective reference regions.

11. The method of data dependence analysis and display according to claim 7, further including:
an output program display step which displays programs outputted by a compiler and also data dependence sources and data dependence destinations.

12. The method of data dependence analysis and display according to claim 3, wherein said programs are input programs to the compiler.

13. A computer-readable storage medium that stores a program for executing a method of data dependence analysis and display that uses a processor to display data dependence sources and data dependence destinations within a specified loop in a program, the data dependence analysis and display method comprising the steps of:
analyzing that data dependence sources or data dependence destinations are within a procedure called from said loop; and
displaying the positions of said data dependence sources or data dependence destinations within said procedure.

14. A data dependence analysis and display apparatus that displays data dependence sources and data dependence destinations within a specified loop in a program, comprising:
means for analyzing that data dependence sources or data dependence destinations are within a procedure called from said loop; and
means for displaying the positions of the data dependence sources or data dependence destinations within said procedure.
